(19) United States
(12) Patent Application Publication
(10) Pub. No.: US 2005/0044331 A1
(43) Pub. Date: Feb. 24, 2005

(54) Data management

(76) Inventor: Mark J. Simms, Bristol (GB)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/827,526

(22) Filed: Apr. 20, 2004

(30) Foreign Application Priority Data
Apr. 22, 2003 (GB) 0309026.3

(51) Int. Cl. G06F 12/00

(52) U.S. Cl. 711/159; 711/156

(57) ABSTRACT

Memory is managed by reading a data block into a block of memory. The memory block has plural smaller memory chunks. For each memory chunk, a record is maintained of whether data stored in the memory chunk is required to be maintained. If the record indicates that data in all the memory chunks need not be maintained, the data block is deleted.

### FIELD OF THE INVENTION

The present invention relates to the management of data.

### BACKGROUND TO THE INVENTION

For design and development of improved tape data storage devices, improvements are tested by testing data which has been written to a tape data storage device via a set of external test programs running on a separate computer entity.

Referring to FIG. 1 herein, there is illustrated schematically a prior art test configuration comprising a computer entity 100 running a set of test programs, reading data from a tape drive unit 101 over a connection 102. Typically, a prior art tape data storage device can store large amounts of data. Individual tape data storage cartridges can store 20 Gbytes of uncompressed data, or 40 Gbytes of compressed data. Other formats can store 100 Gbytes of data on a single cartridge. Further, tape drive units storing multiple cartridges can store 8 or more data cartridges in a single data storage unit. Consequently, the amount of data being read back from a tape drive unit into a set of test programs can be large.

Referring to FIG. 2 herein, there is illustrated schematically components of a known tape drive unit under test, and a test computer receiving data from the tape drive unit for testing the format of the data, and whether the data is correctly written.

Tape drive unit 200 comprises a read/write head 201 for writing data to a tape data storage cartridge 202 and reading data from the cartridge; a chip set of read/write drive electronics 203 including amplifiers and analog to digital converters, for writing data and reading data; one or more data processing circuits 204, including formatters, for formatting data received from a host computer, prior to writing to data and for un-formatting data read from the tape, and for sending back to a test computer; and a communications interface 205 for communicating with the test computer.

Test computer 206 comprises a communications port 207 for communicating with the tape drive unit under test; a data processor 208; a data storage device 209, such as a hard disk data storage device; memory 210 used for buffering data received from the tape drive unit whilst running a series of test applications on the data; a user interface 211 including keyboard, visual display device, and pointing device such as a mouse or the like; and a set of test applications 212 for testing the data and data format of data written to tape by the tape drive unit under test.

The test applications are configured for reading data from a tape drive unit under test, and to test whether the data has been correctly written to a tape data storage medium by the tape drive unit under test. The data is read back from the tape drive unit in large blocks. The test applications reconstruct the data and check that the format is correct and generate error messages alerting to any formatting errors or data errors in the data read back from the tape drive unit. The test applications examine the format of the data, i.e. the way the data has been written to the tape data storage medium by the tape drive unit under test.

Referring to FIGS. 3 and 4 herein, there is illustrated schematically process steps carried out by the known test computer for testing data received from a tape drive unit.

Data blocks are read into an area of main memory from the tape drive unit in process 300. The size of the data blocks is specific to the tape drive unit under test. The data blocks each comprise a plurality of code word pairs. The size of the code word pairs is dependent upon the format being tested. For example typically, a data block comprising 400 code word pairs each of 512 bytes may be stored 301 in main memory of the test computer. In this case, each block has a data capacity of the order 204 Kbytes. A series of data blocks 400-402 are stored in an area of the main memory reserved for data blocks.

For each data block, individual code word pairs are copied into new smaller memory blocks in process 302 and as shown in FIG. 4 herein. When all the code word pairs have been copied into the new smaller memory blocks in process 303, then in process 304, the original data block stored in main memory is deleted. Individual selected code word pairs are processed by the test applications in process 305. Once each code word pair has been processed in process 306, then those code word pairs are deleted from their smaller memory blocks, freeing up that amount of memory for re-use. The individual code word pairs are processed as if they had been read individually. This requires extra memory for storing the data block in addition to the copied codeword pairs whilst they are being copied over, and extra processing power to copy all the data from the main memory area in which the data block was stored in process 301 into the set of smaller memory data blocks as shown in FIG. 4. After copying over into smaller memory blocks, the data block is deleted.

The test applications may need to ‘look ahead’ a number of data blocks, with the number of ‘look ahead’ data blocks being determined by the particular format of data storage, to be sure that all the code word pairs in a data block which have been processed will not be needed for processing any further code word pairs, and therefore all the code word pairs can be safely deleted.

Referring to FIG. 4 herein there is illustrated schematically copying of a plurality of data blocks into a main memory area, and copying of individual code word pairs of those data blocks into a duplicate memory area, so that the duplicate copied code word pairs can be processed.

Since the amount of data stored on a tape data storage cartridge can be large, up to 100 Gbytes, copying of data blocks from the tape drive unit into the main memory of the test computer is a memory intensive operation. The amount of memory available in the test computer is a limitation on the speed at which the data from the tape drive unit can be tested. Further, copying of the data takes up a relatively large amount of processing time, which slows down operation of the test processes.

The data processing time required for copying of data blocks and code word pairs within the memory slows down a test operation.

### SUMMARY OF THE INVENTION

According to a first aspect of the present invention, there is provided a memory management method for managing a memory of a testing device for testing a data storage device, said method comprising: reading a data block from said data storage device into a block of memory, said memory block comprising a plurality of smaller memory chunks; for each said memory chunk, maintaining in real time a record of whether any data stored in said memory chunk is required to be maintained for use by a test program; and under a condition of said records indicating that the data in all of the memory chunks of said data block need not be maintained for use by said test program, deleting said data block.

According to a second aspect of the present invention, there is provided a data management method for managing a plurality of data blocks in a memory device for testing of said data by at least one test program, said method comprising: receiving a plurality of said data blocks in said memory device, each said data block comprising a plurality of data chunks; setting a plurality of flags for indicating whether each of said data blocks are to be maintained or not maintained for reading by said at least one test program; maintaining individual said data blocks having a corresponding said flag indicating that said data block is to be maintained; and deleting said data blocks having flags indicating that said data blocks are not to be maintained.

According to a third aspect of the present invention, there is provided a method of managing a memory for maintaining a plurality of data blocks in a memory device, such that said data blocks are made available to at least one reader device which reads data from said data blocks for processing by at least one test component, said method comprising: reading a said data block into said memory; dividing said data block into a plurality of data chunks; creating a corresponding respective flag for each said data chunk of said data block; initialising said data flag to an “in use” status; selecting individual data chunks of said data block for reading by said reader device; reading a block pointer of a selected said data chunk, said block pointer pointing to said data block; processing a said data chunk using said at least one test component; and applying a flag setting to said data block from which said data chunk originates said flag setting indicating that said data chunk has been processed.

According to a fourth aspect of the present invention, there is provided a reader component for reading a plurality of data chunks from a memory, said reader component comprising respective sub components for: creating flags for a plurality of data chunks, said flags indicating whether each said data chunk is in use or not in use; maintaining a data block flag, said data block flag indicating whether the said data block is in use or not; determining whether said reader device has finished reading from a said data block; and generating a signal for deleting a data block which said reader component has finished reading from.

According to a fifth aspect of the present invention, there is provided a memory management means for managing a plurality of data blocks in a memory, said memory management means comprising: means for effecting receipt of a plurality of said data blocks in said memory, each said data block comprising a plurality of data chunks; means for setting a plurality of data block flags, indicating whether each of said data blocks are in use or not in use by at least one program; and means for determining whether said data blocks are to be maintained in said memory or not, depending on a status of a corresponding said flag indicating that said data block is in use, or is not in use by said at least one program.

According to a sixth aspect of the present invention, there is provided a method of memory management for managing a plurality of memory blocks in a memory device for testing data in said memory blocks, said method comprising: partitioning a plurality of said memory blocks in said memory device, each said memory block comprising a plurality of memory chunks each adapted for storing a corresponding respective data chunk; setting a plurality of flags for indicating whether data stored in each of said memory blocks are to be maintained or not maintained; and maintaining data stored in individual said memory blocks having a corresponding said flag indicating that said data of said memory block is to be maintained.

According to a seventh aspect of the present invention, there is provided a data management method for managing a plurality of data blocks in a memory device, said method comprising: creating a memory block comprising a plurality of memory chunks; storing a block of data in said memory block, such that individual data chunks comprising said data block are stored in said plurality of memory chunks; maintaining a record of a number of active data chunks in said memory block; and under conditions where a said active number of data chunks in a memory block is zero, deleting all of said data blocks from said memory block.

According to an eighth aspect of the present invention, there is provided a memory management method comprising: reading a data block into a block of memory, said memory block comprising a plurality of smaller memory chunks; for each said memory chunk, maintaining a record of whether data stored in said memory chunk is required to be maintained; under a condition of the record indicating that data in all of the memory chunks need not be maintained, deleting said data block.

Other aspects of the present invention are as recited in the claims herein.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 illustrates schematically a known test configuration of a computer running a set of known test applications, for testing data supplied by a known tape drive unit;

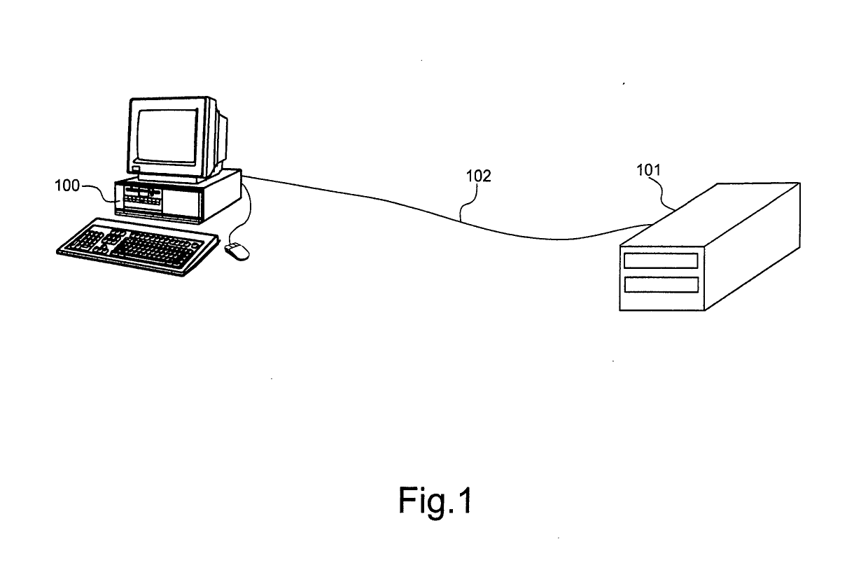

FIG. 2 illustrates schematically components of the known test computer and known tape drive unit;

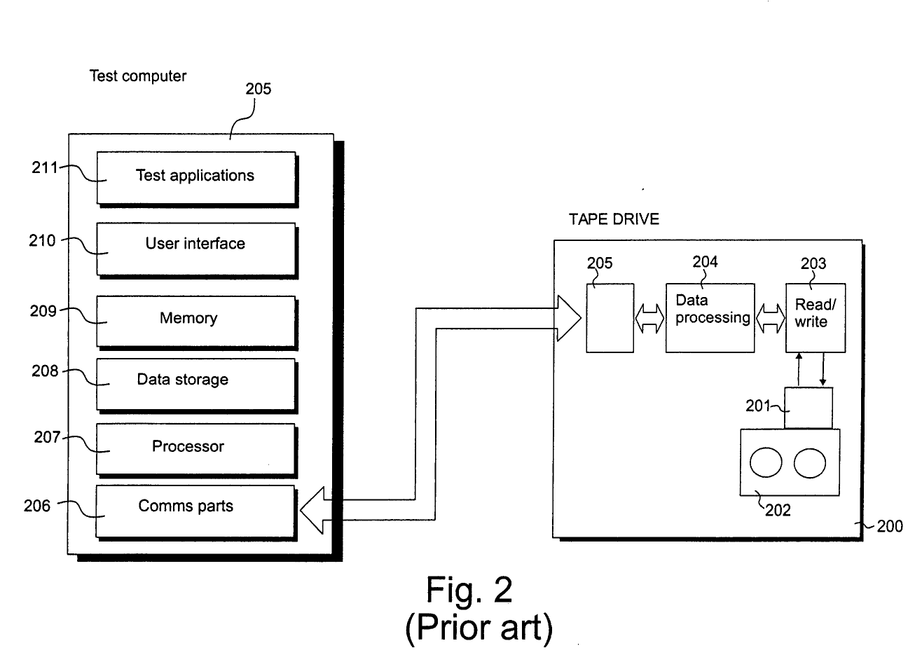

FIG. 3 illustrates schematically process steps carried out by the known test computer for testing data received from the known tape drive unit;

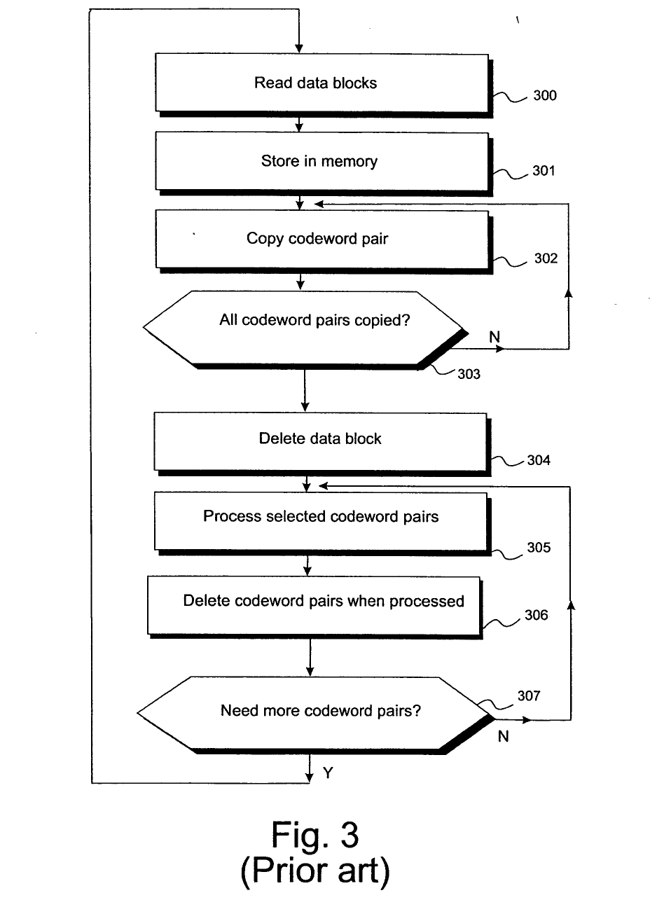

FIG. 4 illustrates schematically copying of a plurality of data blocks into a main memory area with copying of individual code word pairs according to a known test method;

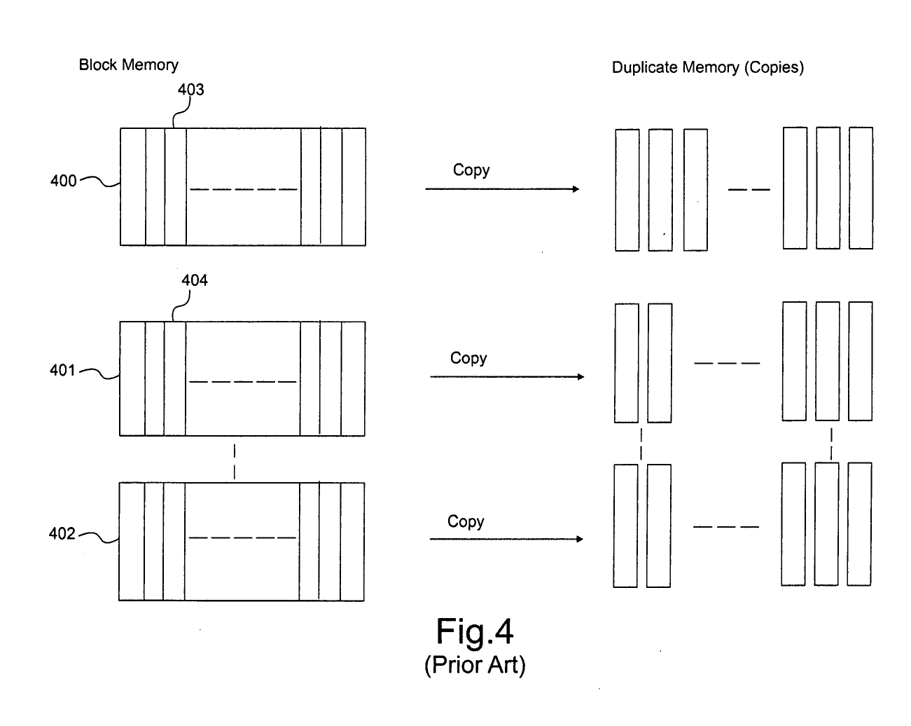

FIG. 5 illustrates schematically a memory and a reader application within a test computer, according to a specific implementation;

FIG. 6 illustrates schematically management of a set of data blocks according to a specific method;

FIG. 7 illustrates schematically processes carried out by a reader device on individual data chunks according to a specific method;

FIG. 8 illustrates schematically operations carried out on a data block by a reader device according to a specific method;

FIG. 9 illustrates schematically operations carried out by reader device on a previous data block stored within memory when the reading device goes on to examine a next data block;

FIG. 10 illustrates schematically operations carried out by a reader device for maintaining a count of code word pairs read from a data block; and

FIG. 11 illustrates schematically processes carried out by a reader device for management of a data block.

### DETAILED DESCRIPTION

There will now be described by way of example a specific mode contemplated by the inventors. In the following description numerous specific details are set forth in order to provide a thorough understanding of the present invention. It will be apparent however, to one skilled in the art, that the present invention may be practiced without limitation to these specific details. In other instances, well known methods and structures have not been described in detail so as not to unnecessarily obscure the description.

In this specification, the term ‘data block’ refers to an amount of data which is read from a tape drive unit, having a size which is specific to a size of data block supplied by the tape drive unit. The amount of data in a data block may vary between different tape drive units.

In this specification, the term ‘memory block’ refers to an amount of memory capacity which is allocated for containing a data block.

In this specification the term ‘data chunk’ is used to refer to a sub division of a data block. A plurality of data chunks form a data block. A data block may comprise an integer number of data chunks, but not necessarily. In some implementations, a data chunk may comprise a code word pair. However, the size of a data chunk is specific to a format in which a particular tape drive unit stores data, and can vary from format to format and between different tape drives.

In the specification, the term ‘memory chunk’ refers to an amount of memory area which is allocated for storing a data chunk.

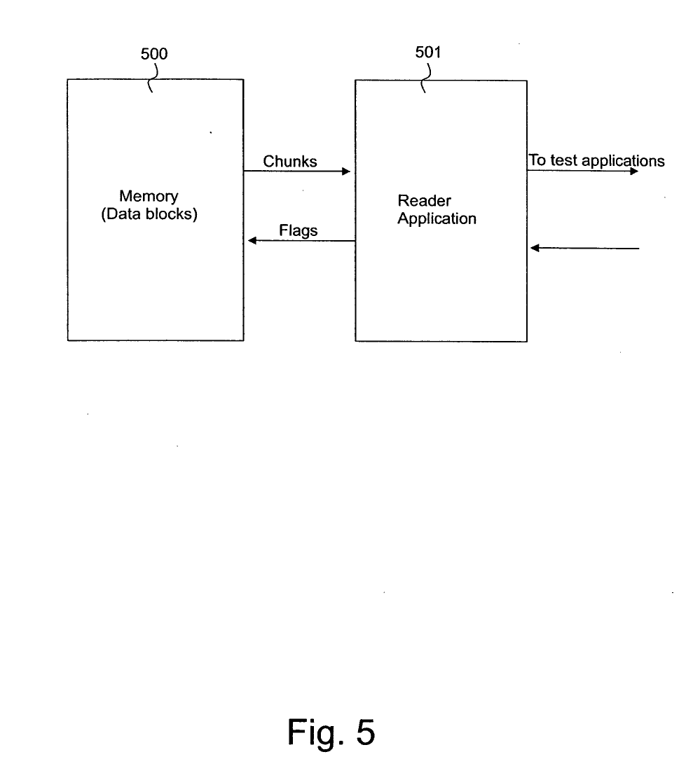

Referring to FIG. 5 herein, there is illustrated schematically interaction between a memory device and a read application, according to the first specific implementation.

Main memory device 500 stores blocks of data, each made up of a plurality of chunks of data. Individual chunks of data are read by the reader application 501 from the memory. The reader application may pass the data chunks onto further test applications for processing, including checking of data formats and other tests to be carried out. The reader application 501 sets flags for each data block, and each data chunk within each data block in the main memory.

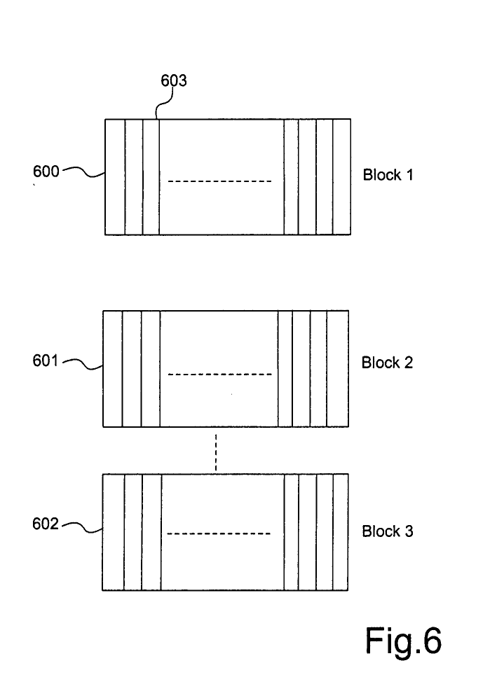

Referring to FIG. 6 herein, there is illustrated schematically a logical arrangement of a plurality of data blocks stored in memory device 500. Each data block 600-602 respectively comprises a plurality of data chunks 603. Associated with each data chunk is a set of data flags which describe a status of the data chunk. Additionally, each data block has a set of block flags which describe the status of the data block. The data chunk flags and the data block flags do not comprise part of the data block or the data chunk respectively, but are stored in separate memory locations within the memory device, or within the computer entity.

In the example shown, a data chunk may comprise a code word pair.

Deletion of data chunks and data blocks within the main memory is carried out when the flags which are set by the reader application indicate that those particular data blocks and data chunks are no longer required by the reader application and the test applications.

The flags which may be set include the following:
A free code word pair flag. This flag indicates whether a data chunk (i.e a code word pair) within the main memory can be over written or not.
A block in use flag. This flag indicates whether a data block is in use or not.
A code word pairs in use flag. This flag indicates a number of code word pairs in use by the test applications and/or reader device.
A reader finished with block flag. This flag indicates whether the reader device has finished with the data block altogether or not, and can have a true or a false status.

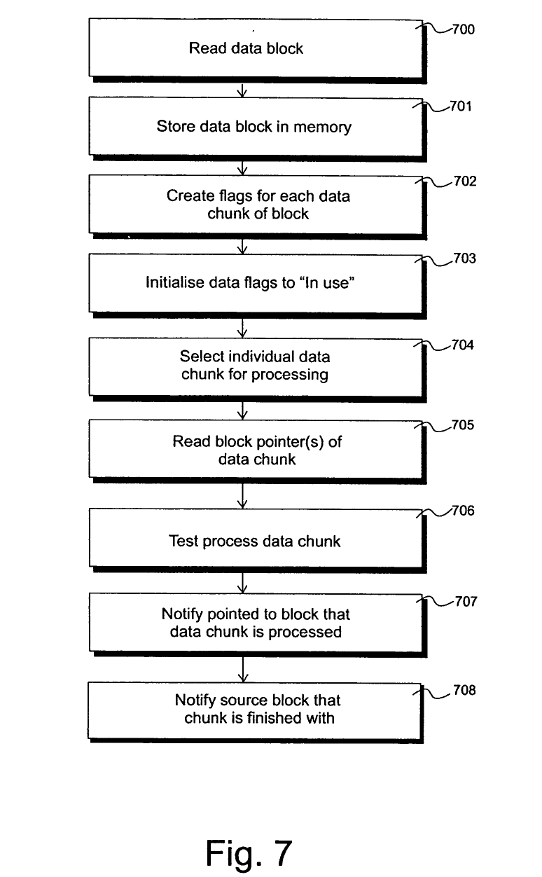

Referring to FIG. 7 herein, there is illustrated schematically processes carried out by the reader device on individual data chunks within the memory. In process 700, data blocks are read from the tape drive unit into the main memory and stored in process 701. The reader device creates flags for each data block, and for each data chunk as described herein in step 702. For each data chunk, data flags are set to a default condition of being in use in process 703. The reader device selects individual data chunks for processing by one or more test applications. When the data chunk is read from the memory, a block pointer of the data chunk is read 705, to see if the data chunk points to any other data blocks. Processing of a data chunk by a test application may require reading of other data chunks in other data blocks. In process 706 the data chunk is tested by the test applications. When the processing of that data chunk has been completed by the test applications, the reader notifies a pointed to block that the data chunk has been processed in step 707. The reader device also notifies the source memory block, being the memory block from which the data chunk was originally read from, that the data chunk is finished with for processing purposes, and sets the ‘in use’ flag of that data chunk in its source data block to a zero value, indicating that the reader device has finished with that data chunk.

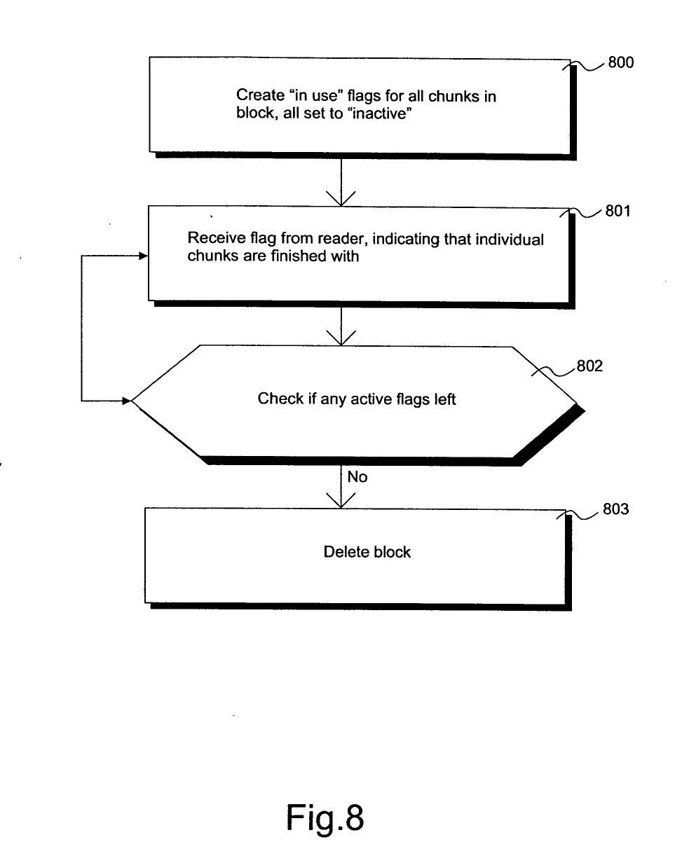

Referring to FIG. 8 herein, there is illustrated schematically operations carried out on a data block by the reader device. In process 800, ‘in use’ activity flags for all chunks of data of the block are set to an ‘active’ state indicating that initially as a default condition, all data chunks are required and cannot be deleted. In process 801, as the reader device receives signals from the test applications indicating that an individual flag has been finished with, the reader device sets the flag for that chunk to be 0 or ‘inactive’, indicating that the chunk is no longer required. In process 802, the reader checks for each data block whether there are any active chunk flags left in that data block. If there are, the reader waits for further information from the test applications that the remaining data chunks for which flags are ‘active’ can now be dispensed with. When all the flags are set to a null value, then this means that all data chunks in the block have been test processed, and the block can be deleted in process 803.

It will be appreciated by that setting a flag to indicate a status of a data chunk is equivalent to setting the flag to indicate a status of a data content of a memory chunk.

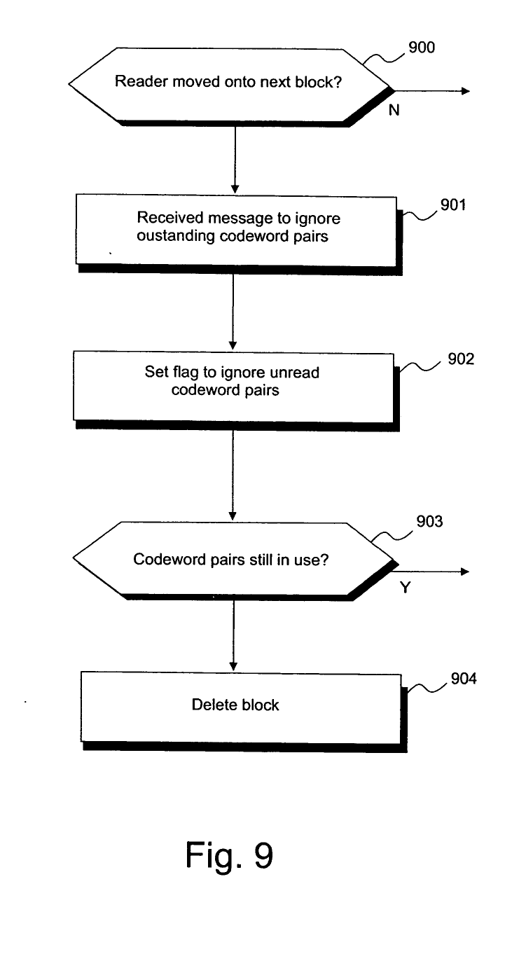

Referring to FIG. 9 herein, under some circumstances, the reader device may move on to process a next data block in process 900, without having finished processing a previous data block, for example because the test applications have done enough testing, and further testing is not required. Under these conditions, not every data chunk in a previous data block may have been test processed, and therefore the test applications cannot return information to the reader device indicating that the data chunks of those blocks are no longer needed.

In process 901 when the reader has moved onto a next data block, the memory receives a message to ignore any outstanding code word pairs in the current data block in process 901. A flag is set to ignore un-read code word pairs in a data block in process 902 if there are no code word pairs still in use 903, then in process 904, the whole data block is deleted. The memory block structure can be deleted once there are no more data chunks in use. Normally, the memory block is only deleted if all the data chunks have been read, and freed.

If no further testing is required, the reader device can generate a message to free up the whole memory block in process 901, which results in deletion of the data block in the memory in the process 902.

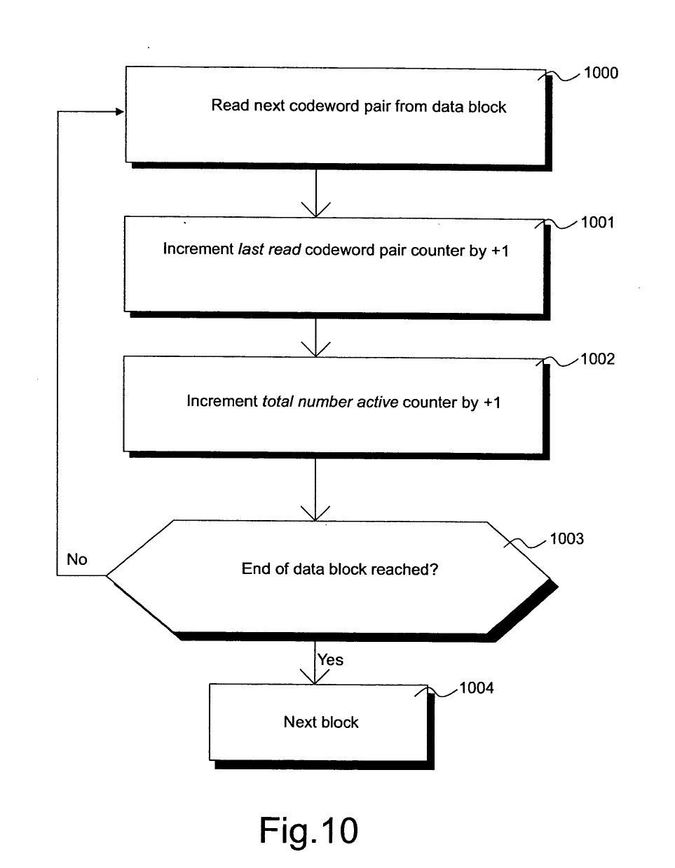

Referring to FIG. 10 herein, there will now be described a second specific implementation, in which successive data blocks are read from a tape drive unit sequentially in order, and successive data blocks are processed by a reader device and test applications sequentially in order, each data block being read from beginning to end.

Under these circumstances, the reader device can be constructed to operate in accordance with an algorithm which maintains data describing a number of the last memory chunk which has been read, and total number of memory chunks which are still active. In the example now described, the data chunks are code word pairs, each of 512 bytes, although the method is not restricted to reading code word pairs and is not restricted to reading data chunks of that particular data size.

In the second specific implementation, when a small memory chunk is freed up, the memory chunk cannot be reallocated, since it is part of the larger memory block. Instead a count of the number of freed memory chunks in the large memory block is increased. If the number of freed memory chunks in the larger memory block structure indicates that all the smaller memory chunks in the larger memory block have been freed, then the large memory block is no longer needed, and the memory resource used for that large memory block can be freed up for re-use.

For each memory block, a record is maintained by the reader device of the information of:
The number of the last code word pair which has been read from the memory block (a last read counter); and
The total number of code word pairs in the memory block which are still active (a total number active counter);

When another code word pair is read from the memory block in process 1000, the last read code word pair number is incremented by one in process 1001, and the total number active counter is incremented by one in process 1002 until the end of the memory block is reached in process 1003.

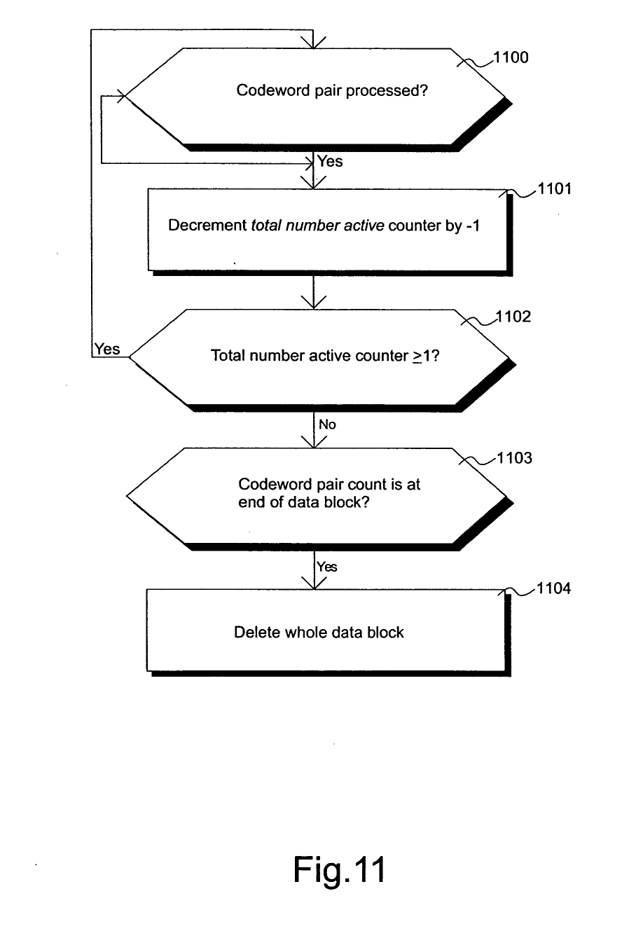

Referring to FIG. 11 herein, when a code word pair is required to be deleted 1100, instead of deleting the code word pair from memory, the number of the active code word pair counter is decremented by one 1101. Therefore, instead of deleting individual code word pairs from a memory block, a count is maintained of the number of active code word pairs in that memory block.

When the code word pair count reaches the end of the data block 1103 and the number of active code word pairs in the block is zero 1102, then this indicates that all information in the data block which is going to be used by the test applications has been used, and therefore the data block is no longer required. The data block can then be deleted.

As long as there is one or more code word pairs within the data block which has an active status, then the whole data block is retained in memory.

There will now be described a specific buffer management method for management of buffer memory by a reader application.

A buffer management process is implemented by program code instructions. The buffer management method can be implementing in an object oriented programming language such as C++.

In the following, a memory block is called a large buffer, and a memory chunk is called a small buffer.

Three classes are needed:

Stream:

A stream class has the following methods:

Constructor:

The constructor class initializes the input method, creates the first large buffer and reads data into it.

Get Next Small Buffer

This class gets the next small buffer (i.e. memory chunk) from the large buffer (i.e memory block). If there are no more small buffers, this class creates a new large buffer, reads more data into it, and gets the next small data buffer.

A large buffer class has the following methods:

Constructor:

The constructor allocates space for the buffer and initializes the number of freed small buffers to 0.

Get Small Buffer:

If there are more small buffers to allocate, this class creates a small buffer object pointing to the correct place in the data buffer and returns it. If there are not, it returns a nil pointer to indicate this.

Free Small Buffer:

This class increases the counter-freed buffers. If all the buffers have been processed and freed, this class returns a true value, or otherwise, if all the buffers have not been processed or freed, then it returns a false value.

Destructor:

This class deallocates buffer space.

The small buffer class has the following methods:

Destructor:

This calls the free small buffer function on the corresponding large buffer. If it returns true, it deallocates the small buffer.

A set of program instructions, suitable for controlling a data processor of a test computer entity for carrying out management of a memory of the test computer according to the second specific implementation comprises the following:

```
const cwpSize = 512;
const cwpInBlock = 400;
// This class is the small block of data that the
// application wishes to process
class Cwp {
    // Pointer to the actual code word pair data
    char *data;
    // Pointer to the block data structure that is
    // associated with the code word pair data
    Block *block;
    // Constructor: Initialises values
    Cwp( char *dataPtr, Block *blockPtr )
    {
        data = dataPtr;
        block = blockPtr;
    }
    // Destructor
    ˜Cwp( )
    {
        if
            // Tell the block we have finished with this
            // code word pair.
            // Return value indiocates whether the
            // whole block is finished with
            ( block->freeCwp( ) )
            {
                // If we are finished with the whole block,
                // delete it
                delete block;
            }
    }
}
// This is the class that represents the large block
// read from the tape drive
class Block {
    // Pointer to the actual data block
    char *data;
    // Flag indicating that the reader has finished
    // with this block
    bool finished;
    // The next code word pair to be returned
    int nextCwp;
    // The number of code word pairs currently in use
    int numberInUse
    // Constructor: Initialises data
    Block( )
    {
        data = new char[ cwpSize * cwpInBlock ];
        read( data, cwpSize * cwpInBlock );
        finished = false;
        nextCwp = 0;
        numberInUse = 0;
    }
    // Returns the next code word pair from the block
    Cwp *getNextCwp( void )
    {
        if
            // We have already returned all the code word pairs
            ( nextCwp == cwpInBlock )
            {
                // Return a null pointer
                return 0;
            }
        else
        {
            // Cretae a new code word pair from the
            // next data block
            Cwp *result = new Cwp( data + nextCwp * cwpSize,
                                this );
            // Increment the counts as required
            nextCwp += 1;
            numberInUse += 1;
            return result;
        }
    }
    // Tell the block we are finished with a code word pair
    bool freeCwp( void )
    {
        // Decrease the number of code word pairs in use
        numberInUse −= 1;
        // Return whether we are finished with the block
        return ( numberInUse == 0 ) &&
                    ( finished || ( nextCwp == cwpInBlock ));
    }
    // Set the flag indicating that the reader is finished
    // Return whether the block should be deleted.
    bool finished( void )
    {
        finished = true;
        return numberInUse == 0;
    }
    // Destructor: frees up data space
    ˜Block( )
    {
        delete [ ]data;
    }
}
```

Specific implementations according to the present invention may have an advantage that copying of data blocks or individual data chunks is not necessary.

Specific implementations described herein may provide access to blocks of data without the need to copy individual chunks of data in memory.

In specific implementations described herein a plurality of data blocks are read into a buffer memory. Each data block is allocated to a contiguous block of memory. The large memory blocks are divided into smaller memory chunks, each of which is capable of storing a data chunk. The smaller data chunks are processed in sequence. The smaller memory chunks become available for re-writing at some later point in time, but are not made available in an order which is easily determined.

Specific implementations operate by being able to determine when each data chunk has been processed, and therefore when all data chunks in a data block have been processed. As soon as all data chunks in a data block have been processed, then the entire data block can be deleted, freeing up the area of memory previously occupied by the whole data block. The specific methods disclosed herein may avoid copying of a whole data block from one area of memory to another, but rather store a data block as a plurality of data chunks once only. Consequently, the need to copy data from one memory area to another may be alleviated, along with the data processing requirement to perform such copying operations.

Specific implementations described herein operate to assign management data to each large memory block and each smaller memory chunk. A large memory block data structure contains a pointer to numbers of each of the smaller memory chunks which have become freed, and which are available for overwriting. Each smaller memory chunk structure contains a pointer to the larger data block in the larger memory block structure and a pointer to its own data.

When a new small memory chunk is required, a next small memory chunk is taken from a current large memory block. If all the small memory chunks have been allocated from the current larger memory block, then a new memory block is created. Data is read into the new large memory block and the data structure of the new large memory block is initialized with no small memory chunks freed. Since the smaller memory chunks are part of the larger memory block, the smaller memory chunks already contain data. The data structure for the large memory block is initialized to return the data from the first smaller memory chunk it contains.

Two specific implementations are described herein.

In a first specific implementation, each memory chunk is allocated a flag, to indicate whether a data chunk in that memory chunk can be overwritten or not.

In a second specific implementation, a count is maintained of a number of small memory chunks which are occupied.

1. A method of managing a memory of a device for testing a data storage device, said method comprising:
reading a data block from said data storage device into a block of memory, said memory block comprising a plurality of smaller memory chunks;
for each said memory chunk, maintaining in real time a record of whether any data stored in said memory chunk is required to be maintained for use by a test program; and
under a condition of said records indicating that the data in all the memory chunks of said data block need not be maintained for use by said test program, deleting said data block.

2. The method as claimed in claim 1, wherein maintaining a record comprises:
for each said memory chunk, maintaining flag data indicating the status of data in said memory chunk.

3. The method as claimed in claim 1, wherein maintaining the record comprises:
maintaining a count of said memory chunks for which the data stored in said memory chunks is required to be maintained.

4. The method as claimed in claim 1, wherein maintaining the record, comprises:
maintaining a count of individual said memory chunks for which data stored in memory chunks is required to be maintained; and
maintaining, for each memory chunk, a pointer to a memory block of which said memory chunk forms a part.

5. The method as claimed in claim 1, wherein maintaining the record comprises:
maintaining for each memory chunk, a pointer to a memory block of which said memory chunk forms a part; and
maintaining a pointer to a data chunk stored in said memory chunk.

6. The method as claimed in claim 1, further comprising:
generating a message to delete said data block in response to a signal from said test program that no further testing of said data block is required.

7. A method of managing plural data blocks in a memory device for testing of data in the blocks by using at least one test program, said method comprising:
receiving a plurality of said data blocks in said memory device, each said data block including plural data chunks;
setting a plurality of flags that indicate whether each of said data blocks is to be maintained or not maintained for reading by said at least one test program;
maintaining said data blocks having a set flag indicating that said data block is to be maintained; and
deleting said data blocks having flags indicating that said data blocks are not to be maintained.

8. The method as described in claim 7, wherein each of said data block comprises at least one data chunk, said method comprising:
for each said data chunk, maintaining a pointer to a data block from which said data chunk originates.

9. The method as claimed in claim 7, comprising maintaining a flag indicating that a reader application has finished processing a data block.

10. The method as claimed in claim 7, wherein each of said data block comprises at least one data chunk, said method comprising maintaining a record of the number of data chunks which are currently in use for one of said data blocks.

11. The method as claimed in claim 7, wherein each of said data block comprises at least one data chunk, said method comprising:
maintaining a counter record indicating the number of data chunks in use for one of said data blocks.

12. The method as claimed in claim 7, comprising:
maintaining flag data indicating whether or not a reader application has finished data processing a data block.

13. A method of managing a memory for maintaining a plurality of data blocks in a memory device, such that said data blocks are made available to at least one reader device which reads data from said data blocks for processing by at least one test component, said method comprising:
reading one of said data blocks into said memory;
dividing said one data block into a plurality of data chunks;
creating a corresponding respective flag for each of said data chunks of said data block;
initialising said data flag to an “in use” status;
selecting individual data chunks of said data block for reading by said reader device;
reading a block pointer of one of the selected data chunks, said block pointer pointing to said data block;
processing said one selected data chunk by using said at least one test component; and
applying a flag setting to said data block from which said one selected data chunk originates, said flag setting indicating that said data chunk has been processed.

14. The method as claimed in claim 13, further comprising:
for each of a plurality of data chunks of said data block, maintaining a corresponding respective data flag indicating whether said data chunk is in use or not;
in response to all of said data flags of said data block having a “not in use” status, deleting said data block from said memory.

15. The method as claimed in claim 13, further comprising:
determining whether any further testing of said data block is required; and
if no further testing of said data block is required, deleting all of said data block.

16. A reader component for reading a plurality of data chunks from a memory, said reader component comprising respective sub-components for:
creating flags for a plurality of data chunks, said flags being arranged for indicating whether each of said data chunks is in use or not in use;
maintaining a data block flag, said data block flag being arranged for indicating whether the said data block is in use or not in use;
determining whether said reader device has finished reading from said data block; and
generating a signal for indicating a data block from which said reader component has finished reading is to be deleted.

17. The reader component as claimed in claim 16, further comprising a for generating a message to indicating that a data block from said memory is to be deleted.

18. A memory manager for managing a plurality of data blocks in a memory, said memory management means comprising:
means for receiving a plurality of said data blocks in said memory, each said data block comprising a plurality of data chunks;
means for setting a plurality of data block flags indicating whether each of said data blocks are in use or not in use by at least one program; and
means for determining whether said data blocks are to be maintained in said memory or not, depending on the status of a flag indicating that said data block is in use, or is not in use by said at least one program.

19. The memory manager as claimed in claim 18, comprising:
means for maintaining a plurality of data pointers for indicating, for each of a plurality of data chunks including plural data blocks, a data block from which each of said data chunks originates.

20. The memory manager as claimed in claim 18, comprising:
means for maintaining a set of flags indicating that a reader application has finished processing one of said data blocks.

21. The manager as claimed in claim 18, comprising:
means for maintaining a record of the number of data chunks which are currently in use in one of said data blocks.

22. The memory manager as claimed in claim 18, comprising:
means for maintaining flag data indicating whether or not a reader application has finished data processing of a data block.

23. The memory manager as claimed in claim 18, further comprising:
means for generating a message to delete said data block from said memory if no further testing of said data block is required.

24. A method of managing a plurality of memory blocks in a memory device for testing data in said memory blocks, said method comprising:
partitioning a plurality of said memory blocks in said memory device, each of said memory block having plural memory chunks each adapted for storing a corresponding respective data chunk;
setting a plurality of flags that indicate whether data stored in each of said memory blocks are to be maintained or not maintained; and
maintaining data stored in individual ones of said memory blocks having a flag indicating that said data of said memory block is to be maintained.

25. A method of managing plural data blocks in a memory device, said method comprising:
creating a memory block having plural memory chunks;
storing a block of data in said memory block, such that individual data chunks include in said data block are stored in said plural memory chunks;
maintaining a record of the number of active data chunks in said memory block; and
under conditions where the active number of data chunks in a memory block is zero, deleting all of said data blocks from said memory block.

26. A memory management method comprising:
reading a data block into a block of memory, said memory block comprising a plurality of smaller memory chunks;
for each said memory chunk, maintaining a record of whether data stored in said memory chunk is required to be maintained;
under a condition of the record indicating that data in all the memory chunks need not be maintained, deleting said data block.

27. The reader component of claim 17, further comprising responding to the message by deleting from said memory the data block from which said reader component has finished reading from said memory.

28. Apparatus for performing the method of claim 1.

29. Apparatus for performing the method of claim 13.

30. Apparatus for performing the method of claim 24.

31. Apparatus for performing the method of claim 25.

32. Apparatus for performing the method of claim 26.
